(19) United States
(12) Patent Application Publication
(10) Pub. No.: US 2006/0132389 A1
(43) Pub. Date: Jun. 22, 2006

(54) Plasma display apparatus and driving method thereof

(75) Inventors: Kyoung Jin Jung, Gumi-si (KR); Ki-Duck Cho, Changwon-si (KR); Sung Im Lee, Gumi-si (KR); Yoonchang Choi, Milyang-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/288,343

(22) Filed: Nov. 29, 2005

(30) Foreign Application Priority Data
Dec. 18, 2004 (KR) 10-2004-0108450

(51) Int. Cl. G09G 3/28

(52) U.S. Cl. 345/63

(57) ABSTRACT

The present invention relates to a plasma display panel, and more particularly, to a plasma display apparatus and driving method thereof, in which they can enhance the capability of representing low gray levels. A plasma display apparatus according to the present invention comprises a PDP comprising a plurality of scan electrodes and a sustain electrodes formed parallel with each other on an upper substrate, and a plurality of address electrodes intersecting the scan electrodes and the sustain electrode on the lower substrate, wherein a discharge cell formed at the intersection of the electrodes is driven with it being time-divided into a plurality of subfields, and a controller that applies a reset pulse for initializing the discharge cell and a scan pulse for selecting the discharge cell to the scan electrodes, whereas a sustain pulse for generating a sustain discharge is omitted, in an nth subfield having the lowest brightness value, and applies a low gray level reset pulse to the scan electrodes in a (n+1 )^{th} subfield.

### CROSS-REFERENCES TO RELATED APPLICATIONS

This Nonprovisional application claims priority under 35 U.S.C. § 119(a) on Patent Application No. 10-2004-0108450 filed in Republic of Korea on Dec. 18, 2004, the entire contents of which are hereby incorporated by reference.

### BACKGROUND OF THE INVENTION

1. Field of the Invention

The present invention relates to a plasma display panel, and more particularly, to a plasma display apparatus and driving method thereof, in which they can enhance the capability of representing low gray levels.

2. Background of the Related Art

A plasma display panel (hereinafter referred to as a “PDP”) displays images including characters or graphics by light-emitting phosphors with ultraviolet of 147 nm generated during the discharge of a mixed inert gas such as He+Xe, Ne+Xe or He+Ne+Xe. This PDP can be easily made thin and large, and it can provide greatly increased image quality with the recent development of the relevant technology. More particularly, a three-electrode AC surface discharge type PDP has advantages of lower voltage driving and longer product lifespan since wall charges are accumulated on a surface upon discharge and electrodes are protected from sputtering generated by a discharge.

FIG. 1 is a perspective view illustrating the structure of a discharge cell of a three-electrode AC surface discharge type PDP in the related art.

Referring to FIG. 1, the discharge cell of the three-electrode AC surface discharge type PDP comprises scan electrodes Y and sustain electrodes Z formed on a bottom surface of an upper substrate 10, and address electrodes X formed on a lower substrate 18. The scan electrode Y comprises a transparent electrode 12Y, and a metal bus electrode 13Y, which has a line width smaller than that of the transparent electrode 12Y and is disposed at one side edge of the transparent electrode. Furthermore, the sustain electrode Z comprises a transparent electrode 12Z, and a metal bus electrode 13Z, which has a line width smaller than that of the transparent electrode 12Z and is disposed at one side edge of the transparent electrode.

The transparent electrodes 12Y, 12Z are generally formed of Indium Tin Oxide (ITO) and are formed on a bottom surface of the upper substrate 10. The metal bus electrodes 13Y, 13Z are generally formed of metal such as chromium (Cr) and are formed on the transparent electrodes 12Y, 12Z. The metal bus electrodes 13Y, 13Z serve to reduce a voltage drop caused by the transparent electrodes 12Y, 12Z having high resistance. On the bottom surface of the upper substrate 10 in which the scan electrodes Y and the sustain electrodes Z are formed parallel to each other is laminated an upper dielectric layer 14 and a protection layer 16. Wall charges generated during the discharge of plasma are accumulated on the upper dielectric layer 14. The protection layer 16 functions to prevent the upper dielectric layer 14 from being damaged by sputtering generated during the discharge of plasma and also to improve emission efficiency of secondary electrons. Magnesium oxide (MgO) is generally used as the protection layer 16.

A lower dielectric layer 22 and barrier ribs 24 are formed on the lower substrate 18 in which the address electrodes X are formed. A phosphor layer 26 is coated on the surfaces of the lower dielectric layer 22 and the barrier ribs 24. The address electrodes X are formed to cross the scan electrodes Y and the sustain electrodes Z. The barrier ribs 24 are formed parallel to the address electrodes X and function to prevent ultraviolet generated by a discharge and a visible ray from leaking to neighboring discharge cells. The phosphor layer 26 is excited with an ultraviolet generated during the discharge of plasma to generate any one visible ray of red, green and blue. An inert mixed gas is injected into discharge spaces provided between the upper substrate 10 and the barrier ribs 24 and between the lower substrate 18 and the barrier ribs 24.

The PDP is time driven with one frame being divided into several subfields having a different number of emissions in order to implement gray levels of an image. Each of the sub fields is divided into a reset period for initializing the entire screen, an address period for selecting a scan line and selecting a cell from the selected scan line, and a sustain period for implementing gray levels according to a discharge number.

The reset period is divided into a set-up period where a ramp-up waveform is applied, and a set-down period where a ramp-down waveform is applied. For example, if it is sought to display an image with 256 gray levels, a frame period (16.67 ms) corresponding to 1/60 seconds is divided into eight subfields (SF1 to SF8), as shown in FIG. 2. Each of the subfields (SF1 to SF8) is divided into a reset period, an address period and a sustain period as described above. The reset period and the address period of each of the subfields (SF1 to SF8) are the same every subfield, whereas the sustain period is increased in the ratio of 2ⁿ (where, n=0,1,2,3,4,5,6,7) in each subfield.

FIG. 3 shows a driving waveform of a PDP, which is supplied to two subfields.

Referring to FIG. 3, the PDP is driven with one frame being divided into a reset period for initializing the entire screen, an address period for selecting a cell, and a sustain period for sustaining the discharge of a selected cell.

In a set-up period of the reset period, a ramp-up waveform (Ramp-up) is applied to the entire scan electrodes Y at the same time. The ramp-up waveform (Ramp-up) causes a weak discharge to be generated in the cells of the entire screen, so that wall charges are generated in the cells. In a set-down period, after the ramp-up waveform (Ramp-up) is applied, a ramp-down waveform (Ramp-down), which falls from a positive (+) voltage lower than a peak voltage of the ramp-up waveform (Ramp-up), is applied to the scan electrodes Y at the same time. The ramp-down waveform (Ramp-down) generates a weak erase discharge within the cells, thus erasing unnecessary charges, such as wall charges generated by the set-up discharge and spatial discharges, and causing wall charges necessary for an address discharge to uniformly remain within the cells.

In the address period, while a negative (−) scan pulse is sequentially applied to the scan electrodes Y, a positive (+) data pulse (Data) is applied to the address electrodes X. As a voltage difference between the scan pulse (Scan) and the data pulse (Data) and a wall voltage generated in the reset period are added, an address discharge is generated within the cells to which the data pulse (Data) is applied. Wall charges are generated within cells selected by the address discharge.

Meanwhile, during the set-down period and the address period, a positive (+) sustain voltage (Vs) is applied to the sustain electrodes Z.

In the sustain period, a sustain pulse (Sus) is alternately applied to the scan electrodes Y and the sustain electrodes Z. A sustain discharge is generated in surface discharge form between the scan electrodes Y and the sustain electrodes Z in cells selected by the address discharge whenever the sustain pulse (Sus) is applied as the wall voltage within the cell and the sustain pulse (Sus) are added. The sustain period is a period, which is essentially included in the entire subfields for the purpose of a discharge for gray level representation. Gray level representation is performed through a discharge of subfields whose luminance weight is different. For example, to represent the minimum luminance not black, only a subfield having the lowest weight is discharged.

FIG. 4 shows a driving waveform for representing the minimum luminance.

Referring to FIG. 4, an n^{th} subfield is a subfield having the lowest weight. Only the n^{th} subfield is discharged in order to represent the minimum luminance.

The driving waveform shown in FIG. 4 will be described below with reference to a discharge voltage curve. The voltage curve is employed as the principle of generating a discharge and a method of measuring voltage margin.

Referring to FIG. 5, a hexagonal region within the voltage curve is an area in which wall charges within a discharge cell are distributed. A discharge is not generated in the hexagonal region. Furthermore, Y(−) indicates a direction where a wall voltage is moved when a negative voltage is applied to the scan electrodes Y. In a similar way, each of Y(+), X(+), X(−), Z(+) and Z(−) indicates a direction where a wall voltage is moved when a negative or positive voltage is applied to the scan electrodes Y or the sustain electrodes Z.

Furthermore, “Vtxy” in a counter discharge region of a quadrant 1 of the voltage curve graph indicates a voltage in which a discharge begins between the address electrodes X and the scan electrodes Y. In other words, the straight line indicating the counter discharge region of the quadrant I of the voltage curve graph is decided as a length as much as a voltage in which a discharge begins between the address electrodes X and the scan electrodes Y. In addition, “Vtzy” in the surface discharge region of the quadrant 1 of the voltage curve graph indicates a voltage in which a discharge begins the sustain electrodes Z and the scan electrodes Y. In the same manner, each of “Vtxz, Vtzx, Vtyz and Vtyx” indicates a discharge firing voltage between the electrodes.

In the case where the driving waveform of FIG. 4 is applied, a wall voltage is located in a quadrant 3 of the graph in a discharge cell in which an address discharge has occurred in an n^{th} subfield, as shown in FIG. 6. Thereafter, if a positive sustain pulse is applied to the scan electrodes Y as shown in FIG. 4, a voltage of the wall charges located in the quadrant 3 and a voltage of the positive sustain pulse are combined, so that its voltage value is moved via a surface discharge region located in the quadrant 3 of the graph (i.e., moved toward a Y(+) side), as shown in FIG. 6. At this time, a sustain discharge is generated between the scan electrodes Y and the sustain electrodes Z in the discharge cell.

After the sustain discharge is generated, the wall voltage is located in the quadrant 1 of the graph as shown in FIG. 7. In addition, a voltage of the wall charges located in the quadrant 1 and a voltage of the positive sustain pulse are combined by means of a positive sustain pulse applied to the sustain electrodes Z, so that its voltage value is moved via the surface discharge region located in the quadrant 1 (i.e., moved toward a Z(+) side) as shown in FIG. 7. At this time, a sustain discharge is generated between the scan electrodes Y and the sustain electrodes Z in the discharge cell. After the sustain discharge is completed, the wall voltage is located at a point A0, i.e., the quadrant 3 of the graph, as shown in FIG. 7 (i.e., this is because the last sustain pulse has been applied to the sustain electrodes Z).

After the sustain period, a ramp-up waveform is applied in an initial stage of the reset period.

Referring to FIG. 8, if a ramp-up waveform (Ramp-up) is supplied to the scan electrodes Y in the set-up period, the cell voltage is moved from a point A0 to a Y(+) side and then reaches a boundary of Vtyz (i.e., a discharge firing voltage) between the scan electrodes Y and the sustain electrodes Z. If the cell voltage reaches a boundary value of the surface discharge region of the quadrant 3 of the graph, a surface discharge is generated between the scan electrodes Y and the sustain electrodes Z. The ramp-up waveform (Ramp-up) is continuously applied until a voltage of Vy. However, an absolute value of a voltage within the cell is not changed as much as the voltage of Vy under the influence of the wall voltage after the surface discharge has been generated, but falls along the boundary of the surface discharge region (i.e., a discharge firing voltage (Vf)). This means that though there is no change in a voltage between the scan electrodes Y and the sustain electrodes Z in which the surface discharge is generated, a potential difference with the address electrodes X is added due to negative (−) charges accumulated on the scan electrodes Y.

The fact that the cell voltage is moved along the boundary value of he surface discharge region, as described above, means that a discharge has been generated. The wall voltage is changed from the location A1 to the location C1 with a slope of ½ due to generation of wall charges.

Meanwhile, if the cell voltage that is varied along the boundary value of the surface discharge region of the quadrant 3 reaches a point F, i.e., the discharge firing voltage between the scan electrodes Y and the sustain electrodes Z, a counter discharge is generated between the scan electrodes Y and the address electrodes X.

While the ramp-up waveform is applied to the scan electrodes Y, the cell voltage is moved along the boundary surface of the counter discharge region between the scan electrodes Y and the sustain electrodes Z past the point F and is changed to the point A2. From a time point where the counter discharge is generated, the surface discharge and the counter discharge are generated at the same time in the discharge space. Since wall charges are also formed in the address electrodes X, the wall voltage is changed from the location C1 to the location C2 with a slope of 1.

Referring to FIG. 9, if a ramp-down waveform (Ramp-Down) subsequent to the ramp-up waveform (Ramp-Up) is applied to the scan electrodes Y, the cell voltage located at the point A2 is changed in the Y(−) direction. When a vector from A2 to A3, which is the amount of change by a positive voltage (Vz) applied to the sustain electrodes Z, is added, a discharge is generated between the scan electrodes Y and the sustain electrodes Z when the discharge firing voltage is generated. At this time, the wall voltage has its location changed from C2 to C3 along with the change of wall charges due to a discharge generated at the point A4. The cell voltage rises in the X(+) direction along the surface discharge region between the scan electrodes Y and the sustain electrodes by means of the ramp-down waveform (Ramp-Down), and generates a counter discharge between the scan electrodes Y and the address electrodes X at a point F′. If the counter discharge is generated between the scan electrodes Y and the address electrodes X, the wall voltage is changed from the location C3 to the point A0 with a slope of 1.

In accordance with the method of driving the PDP in the related art, not only a sustain discharge calculated in the gray level representation is essential even in the process of representing the minimum gray level, but also a discharge is also generated in the address period and the reset period. As can be seen from the optical waveform shown in FIG. 4, the amount of light by a discharge, which is generated in an address period, a sustain period and a reset period of a next frame, is added to a frame for representing the minimum gray level, thus lowering the capability of representing low gray levels. If the capability of representing low gray levels is degraded as described above; a problem arises because contrast for comparison between a low gray level and a high gray level is lowered.

### SUMMARY OF THE INVENTION

Accordingly, an object of the present invention is to solve at least the problems and disadvantages of the background art.

It is an object of the present invention to provide a plasma display apparatus and driving method thereof, in which the capability of representing low gray levels can be improved.

A plasma display apparatus according to the present invention comprises a PDP including a plurality of scan electrodes and a sustain electrodes formed parallel with each other on an upper substrate, and a plurality of address electrodes crossing the scan electrodes and the sustain electrode on the lower substrate, wherein a discharge cell formed at the intersection of the electrodes is driven with it being time-divided into a plurality of subfields, and a controller that applies a reset pulse for initializing the discharge cell and a scan pulse for selecting the discharge cell to the scan electrodes, whereas a sustain pulse for generating a sustain discharge is omitted, in an n^{th} subfield having the lowest brightness value, and applies a low gray level reset pulse to the scan electrodes in a (n+1)^{th} subfield.

In accordance with a method of driving a PDP according to the present invention, a sustain period of a subfield having the lowest brightness value is omitted, and gray levels of the lowest brightness value are represented using the amount of light generated in an address period and the amount of light generated in a reset period of a next subfield. It is thus possible to enhance the capability of representing low gray levels.

### BRIEF DESCRIPTION OF THE DRAWINGS

The invention will be described in detail with reference to the following drawings in which like numerals refer to like elements.

FIG. 1 is a perspective view illustrating the structure of a discharge cell of a three-electrode AC surface discharge type PDP in the related art;

FIG. 2 is a view showing one frame of a PDP;

FIG. 3 shows a driving waveform supplied to electrodes during a subfield period;

FIG. 4 shows a driving waveform for representing the lowest gray level value in the related art;

FIG. 5 is a view showing the location of a wall voltage in a discharge cell in which an address discharge has been generated;

FIG. 6 is a view for illustrating a process in which a sustain discharge is generated when a sustain pulse is applied to a scan electrode Y;

FIG. 7 is a view for illustrating a process in which a sustain discharge is generated when a sustain pulse is applied to a sustain electrode;

FIG. 8 is a view for illustrating variation in a cell voltage and a wall voltage of a set-up period;

FIG. 9 is a view for illustrating variation in a cell voltage and a wall voltage of a set-down period;

FIG. 10 shows a driving waveform according to a first embodiment of the present invention;

FIG. 11 schematically shows the distribution of wall voltage after the set-up period by the driving waveform according to a first embodiment;

FIG. 12 schematically shows the distribution of wall voltage after the set-down period by the driving waveform according to a first embodiment;

FIG. 13 shows a driving waveform of a cell voltage and a wall voltage during the address period by the driving waveform according to a first embodiment;

FIG. 14 shows a driving waveform of a cell voltage and a wall voltage during the set-up period by the driving waveform according to a first embodiment;

FIG. 15 shows a driving waveform of a cell voltage and a wall voltage during the set-don period by the driving waveform according to a first embodiment;

FIG. 16 shows a driving waveform according to a second embodiment of the present invention;

FIG. 17 shows a driving waveform according to a third embodiment of the present invention;

FIG. 18 is a view for illustrating that a strong discharge is generated in the reset period; and

FIG. 19 shows a driving waveform according to a fourth embodiment of the present invention.

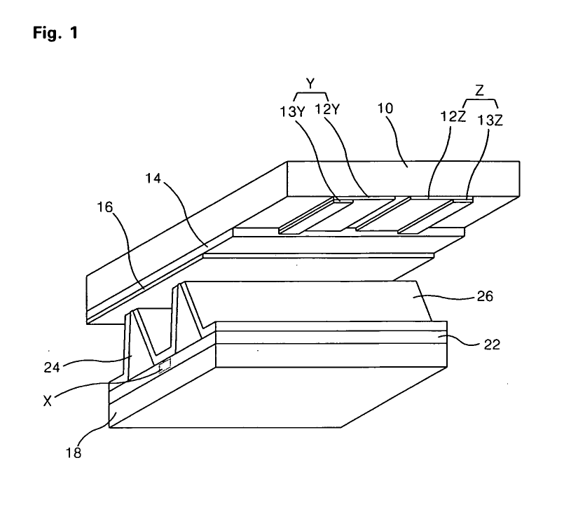

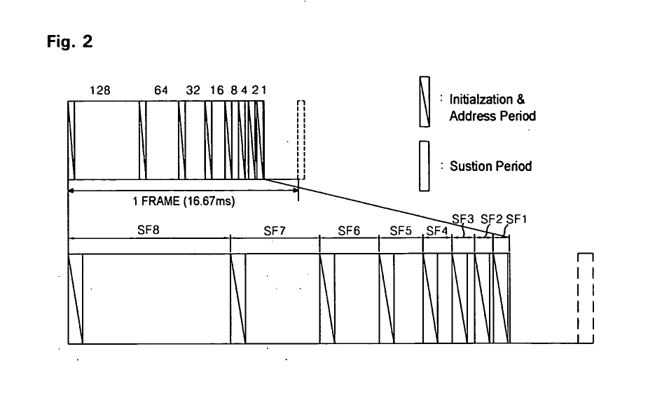

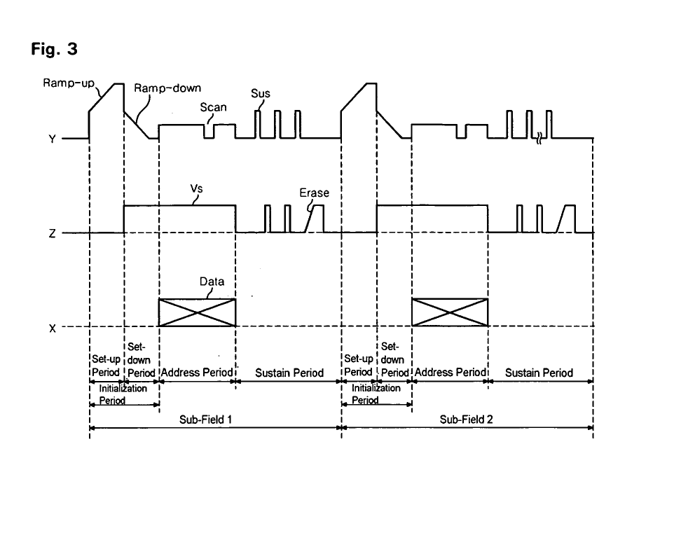

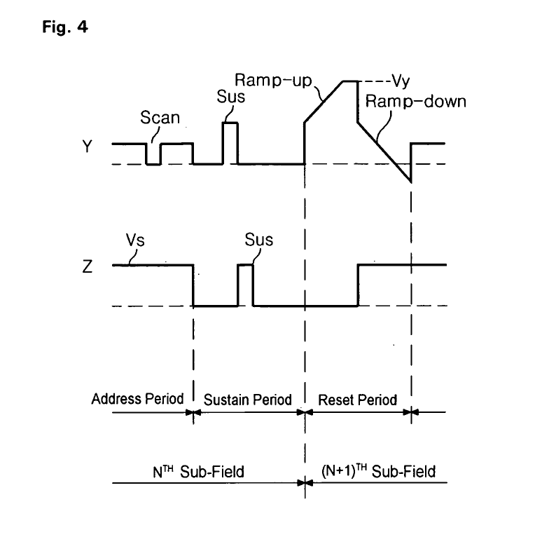

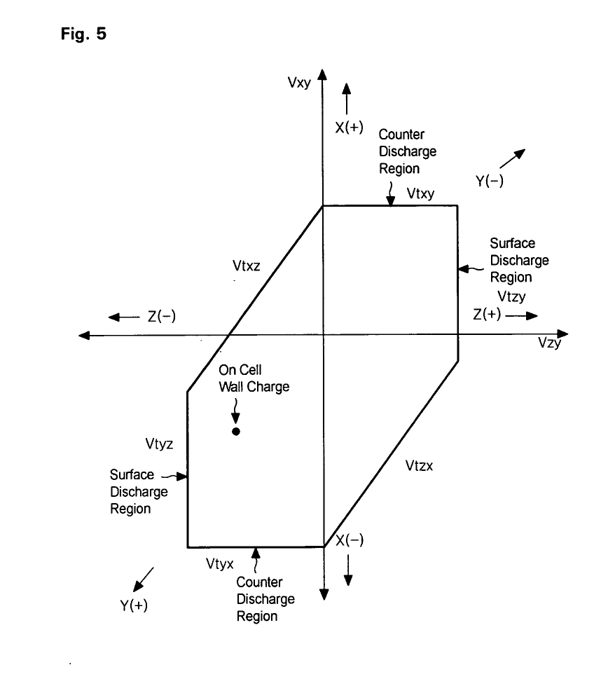

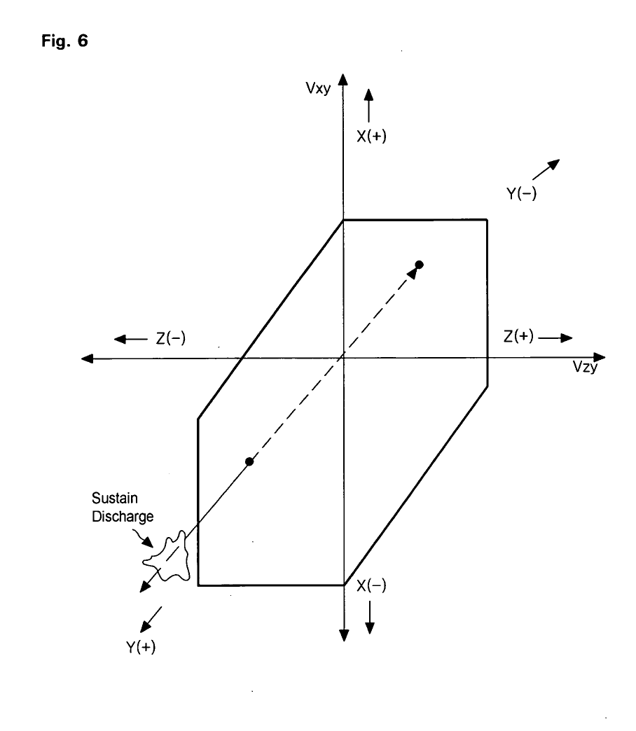

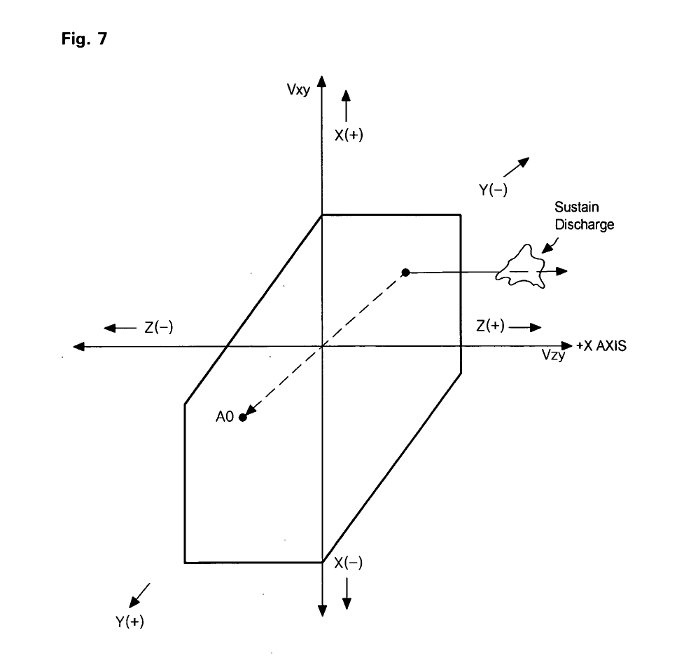

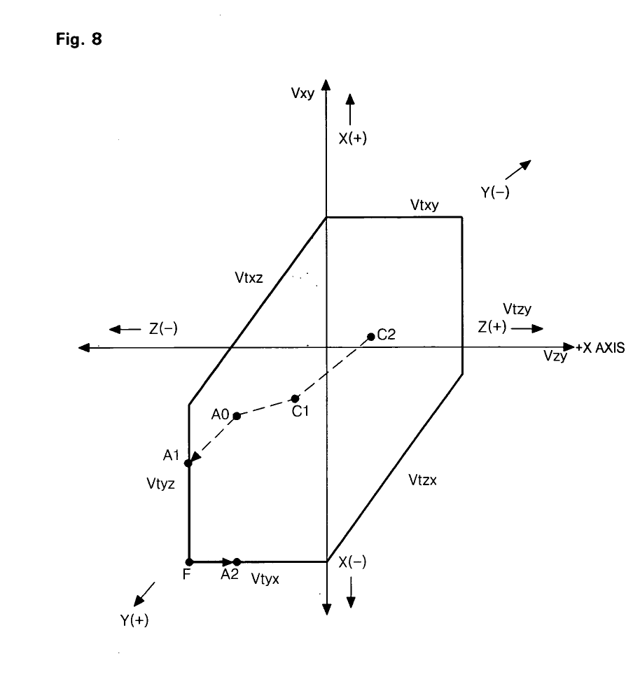

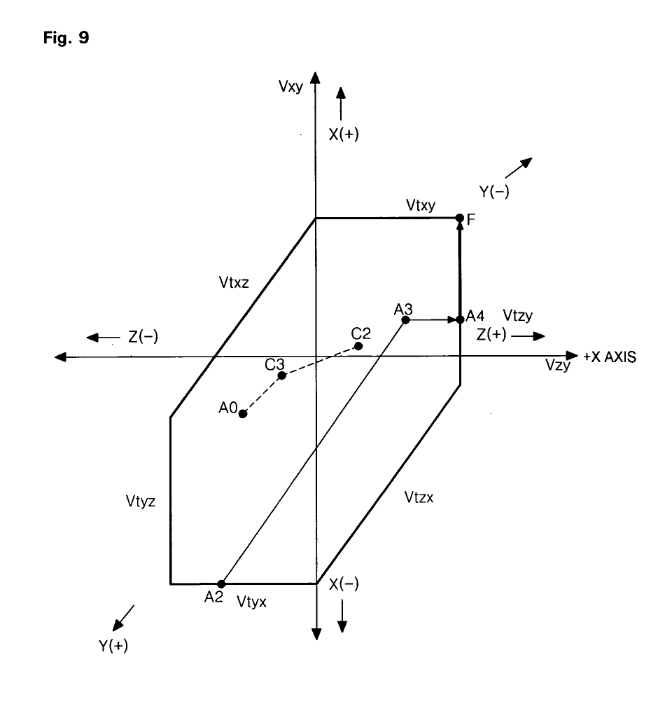

### DETAILED DESCRIPTION OF THE PREFERRED EMBODIMENT

Preferred embodiments of the present invention will be described in a more detailed manner with reference to the drawings.

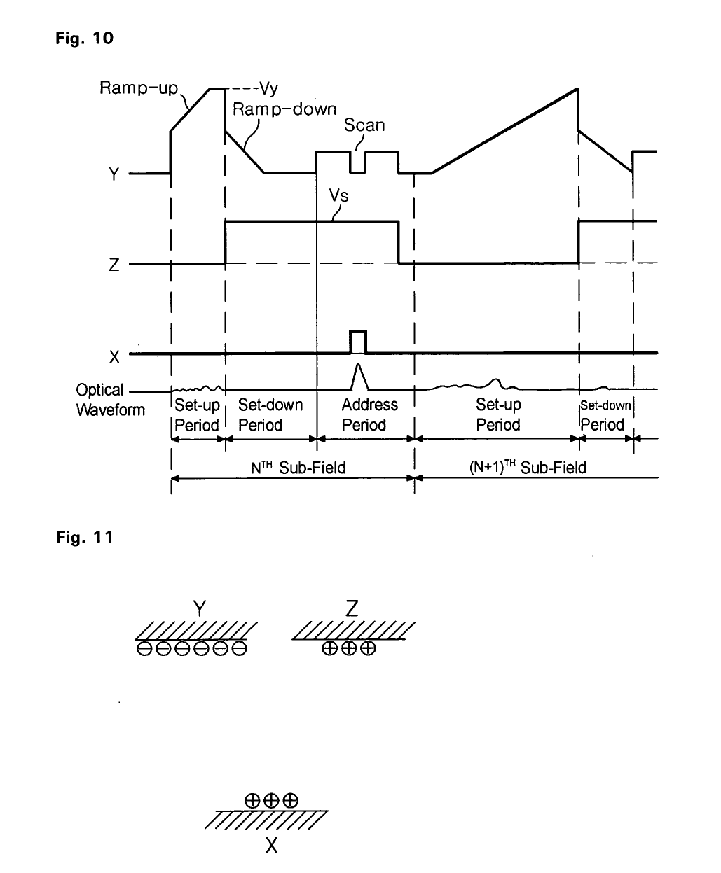

Preferred embodiments of the present invention will be described with reference to FIGS. 10 to 19.

FIG. 10 shows a driving waveform for illustrating a low gray level representation method of a PDP according to a first embodiment of the present invention.

Referring to FIG. 10, the low gray level representation method of the PDP according to a first embodiment of the present invention comprises the steps of applying a scan pulse to scan electrodes Y in an n^{th} subfield period having the lowest brightness value, applying a data pulse to address electrodes, and applying a reset pulse for initializing a cell to the scan electrodes in a subsequent (n+1)^{th} subfield period.

In the n^{th} subfield, in a set-up period, a ramp-up waveform (Ramp-Up) whose voltage value gradually rises from a positive sustain voltage is applied to the scan electrodes Y. The ramp-up waveform (Ramp-Up) is applied up to a voltage value higher than a discharge firing voltage of the scan electrodes Y and sustain electrodes Z. The ramp-up waveform (Ramp-Up) applied to the scan electrodes Y causes a discharge to be generated between the scan electrodes Y and the sustain electrodes Z, which have a surface discharge firing voltage value lower than a counter discharge firing voltage. As a surface discharge is generated, wall charges are formed between the scan electrodes Y and the sustain electrodes Z. That is, negative (−) wall charges are formed in the scan electrodes Y and positive (+) wall charges are formed in the sustain electrodes Z. As wall charges having an opposite polarity to that of the ramp-up waveform (Ramp-Up) (i.e., an external application voltage) is formed between the sustain electrodes pairs, a cell voltage falls less than the discharge firing voltage. If the cell voltage becomes the discharge firing voltage as the ramp-up waveform (Ramp-Up) is continuously applied, wall charges are further formed while a discharge is generated. While this process is repeated, a value of the cell voltage has no change near the discharge firing voltage while the ramp-up waveform is applied, and wall charges are increasingly formed.

Furthermore, a ramp-up waveform higher than a discharge firing voltage is practically applied between the scan electrodes Y and the address electrodes X. Therefore, if the ramp-up waveform reaches a counter discharge firing voltage value, a discharge begins and wall charges are formed between the scan electrodes Y and the address electrodes X. That is, negative (−) wall charges are further formed in the scan electrodes Y and a small amount of positive (+) wall charges is formed in the address electrodes X.

As a result, after the set-up period is completed, a large amount of negative (−) wall charges are formed in the scan electrodes Y and positive (+) wall charges are formed in the sustain electrodes Z and the address electrodes X, in the discharge cell, as shown in FIG. 11.

In a set-down period subsequent the set-up period, a ramp-down waveform (Ramp-Down) whose voltage gradually drops from the sustain voltage to a negative voltage is applied to the scan electrodes Y. While the ramp-down waveform is applied, cells in which the sum of an external application voltage and a wall voltage has reached the discharge firing voltage with wall charge conditions being different every discharge cell start a discharge. In the process in which the ramp-down waveform is applied up to negative voltage, a discharge begins when a difference in a wall voltage by the negative wall charges formed in the scan electrodes Y and positive wall charges formed in the sustain electrodes Z and the sum of the negative voltages applied to the scan electrodes Y reach the discharge firing voltage. While positive (+) wall charges are formed in the scan electrodes Y, the amount of existing negative (−) wall charges is reduced. While negative (−) wall charges are formed in the sustain electrodes Z, positive (+) wall charges, which was a small amount, are erased, and a small amount of negative (−) wall charges is formed.

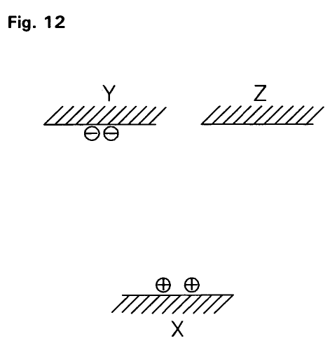

As a result, in the entire cells, a small amount of negative (−) wall charges is formed in the scan electrodes Y and wall charges are rarely formed in the sustain electrodes Z, by means of the discharge up to the set-down period, as shown in FIG. 12. Furthermore, positive (+) wall charges are regularly formed in the address electrodes X.

In other words, a higher electrical potential is formed in the sustain electrodes Z between the scan electrodes Y and the sustain electrodes Z and a higher electrical potential is formed in the address electrodes X between the address electrodes X and the sustain electrode pair, so that the wall voltage is adjusted to the quadrant 1 on the discharge curve.

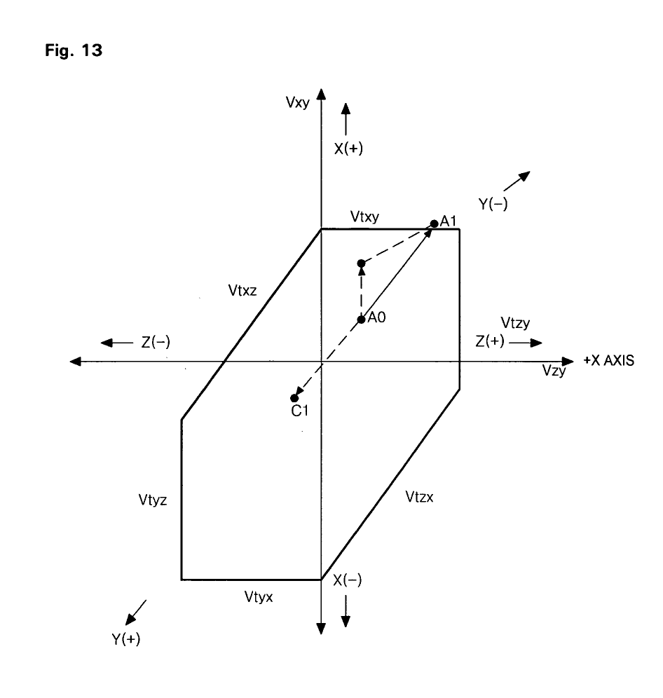

Referring to FIG. 13, if a negative voltage is applied to the scan electrodes Y and a positive voltage is applied to the address electrodes X as external application voltages in the address period with the wall voltage being adjusted to the quadrant 1 on the discharge curve, the cell voltage is changed to the point A1, which is the sum of an amount of changed by an amount of vector that moves in a Z(+) direction and an amount of vector that moves in a Y(−) direction. That is, since the surface discharge firing voltage is exceeded between the scan electrodes Y and the address electrodes X located in the quadrant 1, a discharge is generated. Furthermore, a potential difference of a wall voltage between the scan electrodes Y and the address electrodes X is changed twice than those between the scan electrodes Y and the sustain electrodes Z due to the positive wall charges formed in the scan electrodes Y and the negative wall charges formed in the address electrodes because of inversion of wall charges, which is incurred by the discharge. The wall voltage is then moved on the voltage curve with a slope of 2 and is changed to a point C1.

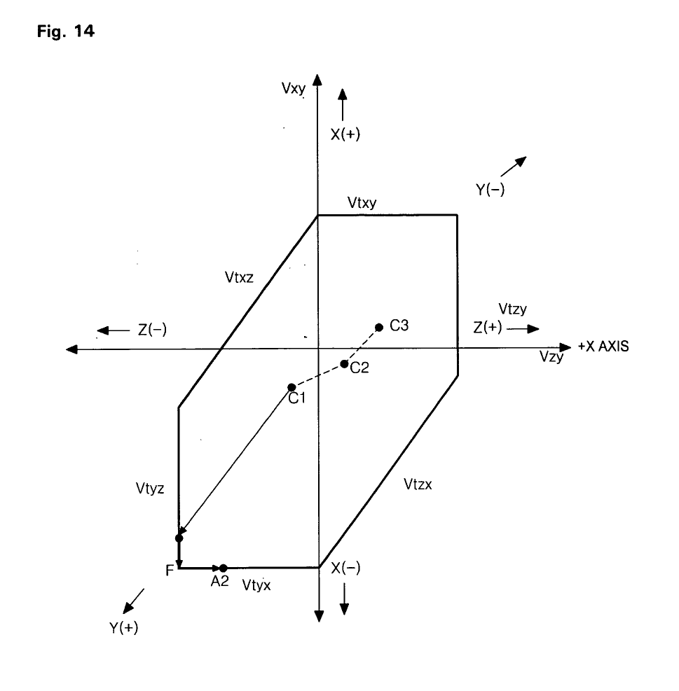

In the start period of an (n+1)^{th} subfield (i.e., a next subfield) subsequent to the n^{th} address period, a ramp-up waveform that gradually rises from a ground voltage is applied. The ramp-up waveform (Ramp-Up) is applied up to Vy, i.e., a voltage value higher than the discharge firing voltage between the scan electrodes Y and the sustain electrodes Z. The cell voltage located at the point C1 is moved in the Y(+) direction due to the application of the ramp-up waveform (Ramp-Up), as shown in FIG. 14, and then reaches the Vtyz axis, i.e., the surface discharge firing voltage between the scan electrodes Y and the sustain electrodes Z. If the cell voltage becomes the surface discharge firing voltage, a discharge is generated between the scan electrodes Y and the sustain electrodes Z. The ramp-up waveform rises to a voltage value of Vy. After the ramp-up waveform reaches the surface discharge firing voltage, the cell voltage drops below the discharge firing voltage due to generation of the wall charges and then reaches the discharge firing voltage. While a weak discharge is generated, the cell voltage is changed along the surface discharge boundary region between the scan electrodes Y and the sustain electrodes Z of the quadrant 3. While the cell voltage passes through the surface discharge boundary region, the wall voltage is changed to the point C2 with a slope of ½ due to generation of the wall charges by the discharge.

The cell voltage is change along the counter discharge region between the scan electrodes Y and the address electrodes X while passing through the point F. While the cell voltage is changed along the counter discharge region while passing through the point F, both the surface discharge and the counter discharge are generated in the discharge cell and the wall voltage is changed from the point C2 to the point C3.

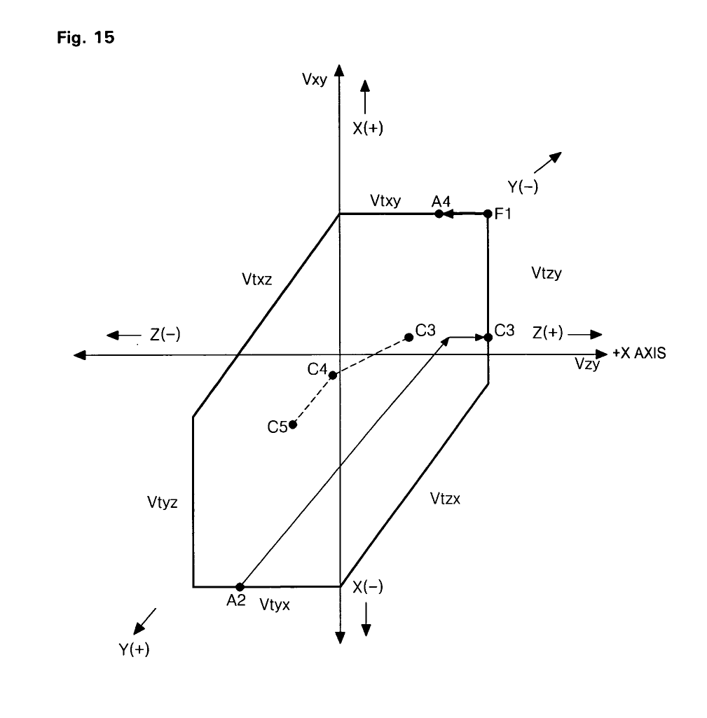

The cell voltage that has moved to the point A2 by the ramp-up waveform (Ramp-Up) applied in the set-up period is moved in the Y(−) direction by the ramp-down waveform (Ramp-Down) applied in the set-down period, as shown in FIG. 15. During the set-down period, a positive voltage is applied to the sustain electrodes Z. The positive voltage has a square wave having a sustain voltage value. The cell voltage is changed in the Z(+) direction by means of the positive voltage applied to the sustain electrodes Z. As a result, an instant discharge in which the sum of voltages applied to the sustain electrodes Z and the sum of variation in voltage by the ramp-down waveform (Ramp-Down) reach the discharge firing voltage between the scan electrodes Y and the sustain electrodes Z begins. While a weak discharge is generated between the scan electrodes Y and the sustain electrodes Z, the wall voltage is changed from C3 to C4 with a slope of ½. The cell voltage rises to a point F1 along the surface discharge region by means of the ramp-down waveform (Ramp-Down) that falls to a voltage of Vy1. If the cell voltage reaches the point F1, a counter discharge is generated between the scan electrodes Y and the address electrodes X and the wall voltage is changed from a point C4 to a point C5 with a slope 1 by means of wall charges formed even in the address electrodes X.

As described above, the low gray level representation method of the PDP according to the present invention can obviate an amount of light by a sustain discharge (i.e., a strong discharge) by omitting the sustain period of the n^{th} subfield having the lowest brightness value. Instead, since the minimal luminance is represented using an address discharge (i.e., a weak discharge) and an amount of light generated in the reset period of the (n+1)^{th} subfield, the capability of representing low gray levels can be increased. Though the intensity of illumination is 3cd or higher in when representing the minimum gray level in the existing method of driving a PDP, representation of the minimum gray level in accordance with the driving method of a PDP of the present invention can represent the intensity of illumination of 1cd. The driving method of a PDP of the present invention can also improve the contrast ratio by increasing the capability of representing low gray levels.

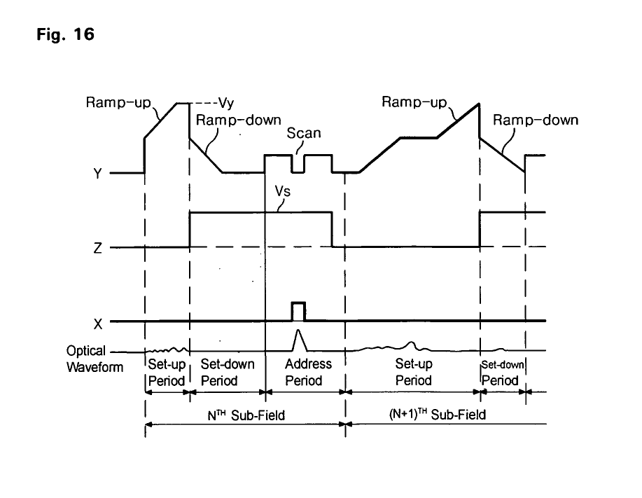

FIG. 16 shows a driving waveform for illustrating a low gray level representation method of a PDP according to a second embodiment of the present invention.

Referring to FIG. 16, the low gray level representation method of the PDP according to a second embodiment of the present invention comprises the steps of applying a scan pulse to scan electrodes Y in an n^{th} subfield period having the lowest brightness value, applying a data pulse to address electrodes, and applying a reset pulse for initializing a cell to the scan electrodes in a subsequent (n+1)^{th} subfield period.

In the present embodiment, the same construction as that of the aforementioned embodiment will not be described.

The present embodiment comprises the steps of applying a ramp waveform in which a ramp-up waveform (Ramp-Up) applied in a (n+1)^{th} subfield period subsequent to an n^{th} subfield period having the lowest brightness value rises from a ground voltage to a sustain voltage value, sustaining the sustain voltage value, and applying a ramp waveform that rises from the sustain voltage value to Vy, i.e., a voltage value higher than a discharge firing voltage between the scan electrodes Y and the sustain electrodes Z. The ramp-up waveform applied in the present embodiment is not substantially different-from the ramp waveform that consecutively rises from the ground voltage to Vy in the first embodiment from a functional viewpoint of the driving waveform. However, the driving waveform according to the second embodiment can simplify the construction of a circuit for implementing it. That is, the ramp waveform that rises to Vy can be implemented by applying a ramp waveform up to a sustain voltage value using a sustain voltage source and adding a voltage value to the voltage value.

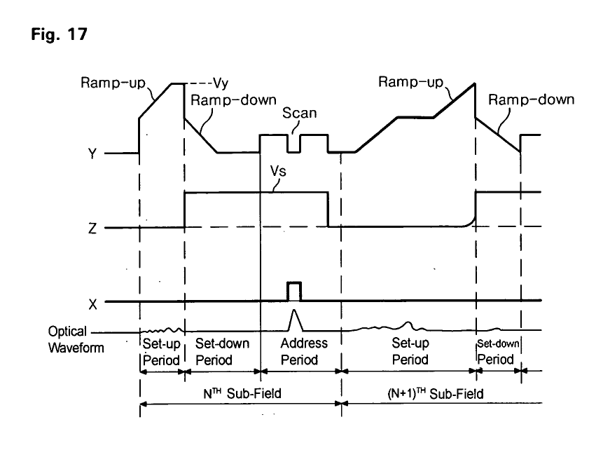

FIG. 17 shows a driving waveform for illustrating a method of representing low gray levels according to a third embodiment of the present invention.

Referring to FIG. 17, the low gray level representation method of the PDP comprises the steps of applying a scan pulse to scan electrodes Y in an n^{th} subfield period having the lowest brightness value, applying a data pulse to address electrodes, and applying a reset pulse for initializing a cell to the scan electrodes in a subsequent (n+1)^{th} subfield period.

After the address period of the n^{th} subfield having the lowest brightness value is completed, a set-up period of a (n+1)^{th} subfield, i.e., a subsequent subfield is completed. A wall voltage of a discharge cell is located at a point C3 shown in FIG. 15.

However, each discharge cell has a different cell condition. The cell condition of the discharge cell may be caused by a panel characteristic formed in its manufacturing or may be caused by the irregularity of conditions of wall charges depending on a discharge number and an amount of the discharge cell. To make regular these irregular conditions, wall charge conditions are made regular during the reset period. However, the entire cells are not substantially regular.

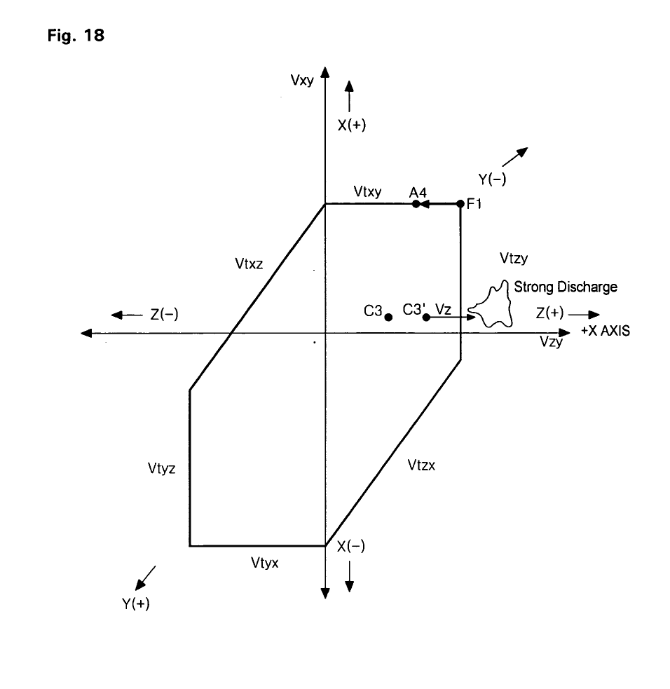

FIG. 18 shows an example in which wall charges of a discharge cell are formed at a location C3′ not C3 after a set-up period is completed. The wall voltage condition is a state where it is very close to the discharge firing voltage between the scan electrodes Y and the sustain electrodes Z. If a positive voltage is applied to the sustain electrodes Z or a negative voltage is applied to the scan electrodes Y, a discharge is generated. After the set-up period, a positive voltage is applied to the sustain electrodes Z in the set-down period, but a ramp waveform that falls from a positive voltage is also applied to the scan electrodes Y. Therefore, a strong discharge is not generated. However, soon before a ramp-down waveform (Ramp-Down) is applied after a ramp-up waveform (Ramp-Up) is applied, there is a case where a voltage is not applied to the scan electrodes Y, but a positive voltage is first applied to the sustain electrodes Z. In this case, a strong discharge is generated since the wall voltage located at the point C3′ instantly goes over the discharge firing voltage between the scan electrodes Y and the sustain electrodes Z by means of the positive voltage applied to the sustain electrodes Z. This phenomenon is caused by a panel characteristic or the irregularity of a discharge cell and results in an erroneous discharge.

Therefore, in the low gray level representation method of a PDP according to the third embodiment, the method of applying the positive voltage to the sustain electrodes in the set-down period of the (n+1)^{th} subfield subsequent to the n^{th} subfield having the lowest brightness value comprises the steps of floating a voltage of the sustain electrodes Z in the latter half of the set-up period, and applying a square wave of a sustain voltage value to the sustain electrodes Z. If the voltage is applied with it being floated without directly applying the square wave of the sustain voltage value, a strong discharge can be prevented from occurring when the set-up period is changed to the set-down period depending on a panel characteristic. It is thus possible to prevent an erroneous discharge.

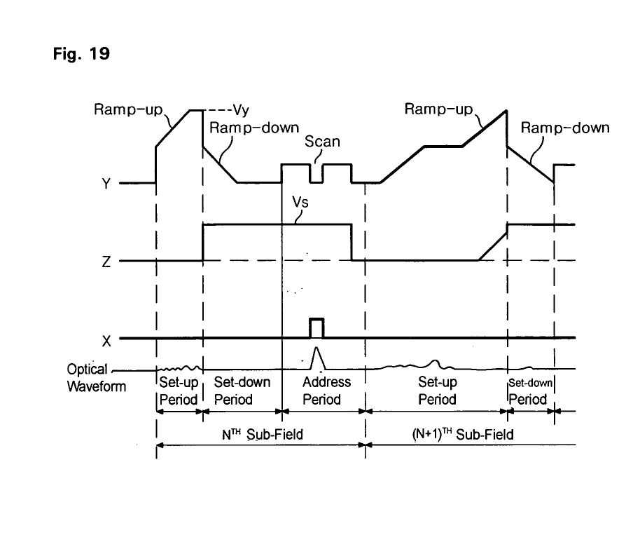

FIG. 19 shows a driving waveform for illustrating a method of representing low gray levels according to a fourth embodiment of the present invention.

Referring to FIG. 19, the low gray level representation method of the PDP according to a fourth embodiment of the present invention comprises the steps of applying a scan pulse to scan electrodes Y in an n^{th} subfield period having the lowest brightness value, applying a data pulse to address electrodes, and applying a reset pulse for initializing a cell to the scan electrodes in a subsequent (n+1)^{th} subfield period.

In the present embodiment, a method of applying a positive voltage to the sustain electrodes when a set-up period is changed to a set-down period comprises the steps of applying a ramp-up waveform (Ramp-Up), i.e., a sub rising waveform in the latter half of the set-up period, and applying a square wave of a sustain voltage value at the start point of the set-down period.

As the ramp-up waveform (Ramp-Up), i.e., a sub rising waveform is applied in the latter half of the set-up period, generation of a strong discharge can be prevented and an erroneous discharge can be prevented accordingly, as in the third embodiment.

The ramp-up waveform (Ramp-Up) applied in the latter half of the set-up period is set to have a slope that can prevent generation of a strong discharge.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of driving a PDP comprising a plurality of scan electrodes and a sustain electrode formed -in parallel with each other on an upper substrate, and a plurality of address electrodes intersecting the scan electrodes and the sustain electrode on a lower substrate, wherein a discharge cell formed at the intersection of the electrodes is driven by being time-divided into a plurality of subfields,
wherein in a n^{th} subfield having the lowest brightness value, a reset pulse for initializing the discharge cell and a scan pulse for selecting the discharge cell are applied to the scan electrodes, whereas a sustain pulse for generating a sustain discharge is omitted, and in a (n+1)^{th} subfield, a low gray level reset pulse is applied to the scan electrodes.

2. The method as claimed in claim 1, wherein in the n^{th} subfield, the reset pulse comprises:
a ramp-up waveform whose voltage gradually rises from a first voltage level of a sustain voltage value to a second voltage level, i.e., a voltage value that is more than a firing voltage to the scan electrodes, and
a ramp-down waveform whose voltage gradually falls from the first voltage level to a third voltage level, i.e., a negative voltage value to the scan electrodes, after the ramp-up waveform.

3. The method as claimed in claim 1, wherein in the (n+1)^{th} subfield, the low gray level reset pulse comprises:
a rising waveform whose voltage value gradually rises from a ground voltage level to a second voltage level to the scan electrodes; and
a falling waveform whose voltage value gradually falls from a first voltage level to a third voltage level to the scan electrodes.

4. The method as claimed in claim 1, wherein in the (n+1)^{th} subfield, the low gray level reset pulse comprises:
a rising waveform whose voltage value gradually rises from a ground voltage level to a first voltage level;
a waveform in which the first voltage level remains at a substantially constant level; and
a rising waveform whose voltage value gradually rises from the first voltage level to the second voltage level.

5. The method as claimed in claim 2, further comprises the step of applying a positive voltage to the sustain electrode while the falling waveform is applied.

6. The method as claimed in claim 5, wherein the positive voltage is a sustain voltage value.

7. The method as claimed in claim 5, wherein the step of applying the positive voltage to the sustain electrode during the (n+1)^{th} subfield comprises the steps of:
floating the voltage at a ground voltage level in the closing part of the rising waveform; and
applying the positive voltage subsequent to the floating voltage.

8. The method as claimed in claim 5, wherein the step of applying the positive voltage to the sustain electrode during the (n+1)^{th} subfield comprises the steps of:
applying a sub rising waveform to the sustain electrode in the closing part of a rising waveform applied to the scan electrodes; and
applying the positive voltage to the sustain electrode subsequent to the sub rising waveform.

9. The method as claimed in claim 8, wherein the sub rising waveform has a voltage that gradually rises from a ground voltage level to a voltage that is less than the sustain voltage value.

10. A plasma display apparatus, comprising:
a PDP comprising a plurality of scan electrodes and a sustain electrodes formed in parallel with each other on an upper substrate, and a plurality of address electrodes intersecting the scan electrodes and the sustain electrode on the lower substrate, wherein a discharge cell formed at the intersection of the electrodes is driven with it being time-divided into a plurality of subfields; and
a controller that applies a reset pulse for initializing the discharge cell and a scan pulse for selecting the discharge cell to the scan electrodes, whereas a sustain pulse for generating a sustain discharge is omitted, in an n^{th} subfield having the lowest brightness value, and applies a low gray level reset pulse to the scan electrodes in a (n+1)^{th} subfield.

11. The plasma display apparatus as claimed in claim 10, wherein in the n^{th} subfield, the reset pulse comprises:
a ramp-up waveform whose voltage gradually rises from a first voltage level of a sustain voltage value to a second voltage level, i.e., a voltage value that is more than a firing voltage to the scan electrodes, and
a ramp-down waveform whose voltage gradually falls from the first voltage level to a third voltage level, i.e., a negative voltage value to the scan electrodes, after the ramp-up waveform.

12. The plasma display apparatus as claimed in claim 10, wherein in the (n+1)^{th} subfield, the low gray level reset pulse applied to the scan electrodes comprises:
a rising waveform whose voltage value gradually rises from a ground voltage level to a second voltage level; and
a falling waveform whose voltage value gradually falls from a first voltage level to a third voltage level.

13. The plasma display apparatus as claimed in claim 10, wherein in the (n+1)^{th} subfield, the low gray level reset pulse comprises:
a rising waveform whose voltage value gradually rises from a ground voltage level to a first voltage level;
a waveform in which the first voltage level remains at a substantially constant level; and
a rising waveform whose voltage value gradually rises from the first voltage level to the second voltage level.

14. The plasma display apparatus as claimed in claim 11, wherein when the falling waveform is applied, a positive voltage applied to the sustain electrode.

15. The plasma display apparatus as claimed in claim 14, wherein the positive voltage is a sustain voltage value.

16. The plasma display apparatus as claimed in claim 14, wherein in the (n+1)^{th} subfield, the controller floats the voltage at a ground voltage level in the closing part of the rising waveform, and applies the positive voltage subsequent to the floating voltage.

17. The plasma display apparatus as claimed in claim 14, wherein the controller applies a sub rising waveform to the sustain electrode in the closing part of a rising waveform applied to the scan electrodes and applies the positive voltage to the sustain electrode subsequent to the sub rising waveform.

18. The plasma display apparatus as claimed in claim 17, wherein the sub rising waveform has a voltage that gradually rises from a ground voltage level to a voltage lower than the sustain voltage value.

19. A plasma display apparatus, comprising:
a PDP comprising a plurality of scan electrodes and a sustain electrodes formed parallel with each other on an upper substrate, and a plurality of address electrodes intersecting the scan electrodes and the sustain electrode on the lower substrate, wherein a discharge cell formed at the intersection of the electrodes is driven by being time-divided into a plurality of subfields; and
a controller that applies a reset pulse for initializing the discharge cell and a scan pulse for selecting the discharge cell to the scan electrodes, whereas a sustain pulse for generating a sustain discharge is omitted, in an n^{th} subfield having the lowest brightness value, and applies a low gray level reset pulse to the scan electrodes in a (n+1)^{th} subfield,
wherein the sustain electrode is applied with a sub rising waveform in the closing part of a rising waveform applied to the scan electrodes, and applied with the positive voltage subsequent to the sub rising waveform.

20. The plasma display apparatus as claimed in claim 19, wherein the sub rising waveform has a voltage that gradually rises from a ground voltage level to a voltage that is less than the sustain voltage value.
